(19) United States
(12) Patent Application Publication
(10) Pub. No.: US 2017/0348904 A1
(43) Pub. Date: Dec. 7, 2017

(54) THREE-DIMENSIONAL SELECTIVE REPAIRING SYSTEM, APPARATUS AND APPLICATION METHOD THEREOF

(71) Applicant: NATIONAL TSING HUA UNIVERSITY, HSINCHU (TW)

(72) Inventors: Jen-Yuan CHANG, Hsinchu County (TW); Shao-Wei YEH, Taoyuan City (TW); Teng-Yueh TSAO, Taipei City (TW)

(21) Appl. No.: 15/236,496

(22) Filed: Aug. 15, 2016

(30) Foreign Application Priority Data
Jun. 1, 2016 (TW) 105117217

(51) Int. Cl. B29C 64/141; B29C 64/393; B33Y 40/00; B33Y 10/00; B33Y 30/00

(52) U.S. Cl. CPC B29C 64/141; B29C 64/393; B33Y 30/00; B33Y 10/00; B33Y 40/00

(57) ABSTRACT

A three-dimensional selective repairing system, which is for selectively repairing an area of an unrepaired element by sintering, includes a scanning device, a comparing device, a spraying device and a sintering device. The scanning device is for scanning the area to obtain a repairing data. The comparing device is connected to the scanning device to receive the repairing data and produce a repairing parameter. The spraying device is controlled by the repairing parameter and includes an electrostatic generator which sprays a plurality of electrified pulverulent bodies through the electrostatic generator to form an electrified pulverulent film on a medium covered on the area. The sintering device is controlled by the repairing parameter to provide a power beam to selectively heat the electrified pulverulent film. The electrified pulverulent film melted or sintered to form a solid mass on the area.

### RELATED APPLICATIONS

This application claims priority to Taiwan Application Serial Number 105117217, filed Jun. 1, 2016, which is herein incorporated by reference.

### BACKGROUND

### Technical Field

The present disclosure relates to a three-dimensional sintering device and an application method thereof. More particularly, the present disclosure relates to a three-dimensional selective repairing system, an apparatus and an application method thereof, which can do partial repair and precise curved-surface repair during three-dimensional repairing process.

### Description of Related Art

Manufacturing methods, such as conventional foundry, only can produce articles having fixed shape. If it desires to strengthen material characteristic of articles, such as strength or hardness for different demands, an addictive manufacturing method can be adapted to process articles which has accurate shape or which is made of metal material according to different demands.

Powdered material binding technique, such as selective laser sintering (SLS), selective laser melting (SLM), or electron beam melting (EBM), is a predominate technique of additive manufacturing method. Through using the SLS, the structure of an article is divided into a plurality of two-dimensional geometric layers base on the three-dimensional model of an article. The powdered materials can be formed into layers with proper thickness by a supplying unit, and the powdered materials can be selectively heated by the laser beam so as to be sintered and bond as the three-dimensional article. Through using the SLM, the structure of an article is divided into a plurality of two-dimensional geometric layers base on the three-dimensional model of an article. The powdered materials can be formed into layers with proper thickness by a supplying unit, and the powdered materials can be selectively heated by the laser beam so as to be bond as the three-dimensional article. Through using the EBM, the powdered materials can be formed into layers with proper thickness by a supplying unit, and the powdered materials can be selectively heated by the electron beam so as to be melted and bond as the three-dimensional article.

According to the aforementioned addictive manufacturing process, a transition between a liquid phase and a solid phase and the crystallization mechanism are the key points during the cooling and solidifying processes. The conventional addictive manufacturing technique is usually used to produce single article because the powder is not easily positioned on the constructing place. If a broken part needs to be repaired, the powder is hard to be positioned as a result of lacking of a flat surface; therefore, the conventional addictive manufacturing method cannot be used to repair, and precise quality cannot be achieved. Accordingly, the addictive manufacturing method is limited in a specific scope, and the utilization of the three-dimensional repair is limited and cannot be controlled arbitrarily.

Hence, the main application of the addictive manufacturing method is for manufacturing prototype molds or using in aerospace industry, medical industry etc., but not for repairing purpose in recent years. To solve this problem, a new addictive manufacturing technique similar to SLE is developed. During the manufacturing process, a mold which is corresponded to the area of the unrepaired element is provided, and metal powder is putted into the mold. The metal powder can be sintered by laser beam to form a solid metal, or the formed solid metal can be welding onto the unrepaired element. However, it is hard to use in three-dimensional repair. Furthermore, the addictive manufacturing method cannot be exploited if the mold is hard to be manufactured.

Because components of the aviation industry or space industry are hard to obtain and the price of the components are expensive, a demand for repairing the components exists. Accordingly, for a manufacturer who needs to produce lots of molds, life time of the molds is limited because the molds are easily to be broken due to friction occurs between articles and modes during mode releasing process. Hence, addictive manufacturing method can repair the mold and extend the life time of the mold. Moreover, for industrial product using on the ocean and industry relative to national defense, articles made of metal are easily corroded. The addictive manufacturing technique is going to repair the articles and bring them back to work.

Therefore, how to use the addictive manufacturing method in three-dimensional surface repair without using molds becomes an important question for practitioners.

### SUMMARY

According to one structure aspect of the present disclosure, a three-dimensional selective repairing system, which is for selectively repairing an area of an unrepaired element by sintering, is provided. The area is covered by a medium. The three-dimensional selective repairing system includes a scanning device, a comparing device, a spraying device and a sintering device. The scanning device is for scanning the area to obtain a repairing data. The comparing device is connected to the scanning device to receive the repairing data and produces a repairing parameter after calculating. The spraying device is controlled by the repairing parameter of the comparing device, which includes an electrostatic generator. The spraying device sprays a plurality of electrified pulverulent bodies through the electrostatic generator to form an electrified pulverulent film on the medium. The electrified pulverulent bodies are coordinated with the medium to magnetically attach to the area. The sintering device is controlled by the repairing parameter of the comparing device to provide a power beam to selectively heat the electrified pulverulent film. The electrified pulverulent film is melted or sintered to form a solid mass on the area.

According to one method aspect of the present disclosure, an application method for applying to the three-dimensional selective repairing system includes the followings. Perform a scanning step to scan the area to obtain the repairing data by the scanning device. Perform a comparing step to connect the comparing device to the scanning device to receive the repairing data. The comparing device produces a repair parameter after comparing and calculating. Perform a powder locating step. The spraying device is moved according to the repairing parameter. The spraying device is coordinated with the medium to allow the electrified pulverulent bodies to be magnetically disposed on the area and form the electrified pulverulent film with certain thickness at a certain position. Perform a sintering device locating step to move the sintering device based on the repairing parameter. Performing a sintering step to exert the scanning device based on the repairing parameter so as to allow the electrified pulverulent bodies to be sintered and form a solid mass on the area.

According to another structure aspect of the present disclosure, a three-dimensional selective repairing apparatus, which is for repairing an area of an unrepaired element with positive electric charges, is provided. The area is covered by a medium which is non-conductive. The three-dimensional selective repair apparatus includes a main body, a spraying device and a sintering device. The spraying device is disposed at and linked with the main body, which includes an electrostatic generator. The spraying device sprays a plurality of electrified pulverulent bodies with negative electric charges toward the medium through the electrostatic generator to form an electrified pulverulent film on a surface of the medium. The electrified pulverulent bodies are coordinated with the medium to magnetically attach to the area. The sintering device is disposed at and linked with the main body. The sintering device is controlled to provide a power beam to selectively heat the electrified pulverulent film. The electrified pulverulent film is melted or sintered to form a solid mass on the area.

According to another method aspect of the present disclosure, an application method for applying to the three-dimensional selective repairing apparatus is provided. The application method includes the followings. Perform a medium covering step to cover the medium onto the area by spraying or coating. Perform a powder locating step. The spraying device is coordinating with the medium to allow the electrified pulverulent bodies to be magnetically disposed onto the area to form an electrified pulverulent film with certain thickness at a certain position. Perform a sintering device locating step to move the sintering device via the main body. Perform a sintering step to sintering the electrified pulverulent film to form a solid mass on the area by the sintering device.

### BRIEF DESCRIPTION OF THE DRAWINGS

The disclosure can be more fully understood by reading the following detailed description of the embodiments, with reference made to the accompanying drawings as follows:

FIG. 1 shows a schematic diagram of a three-dimensional selective repairing system according to a first embodiment of the present disclosure;

FIG. 2A shows a schematic diagram of a medium spraying status of the three-dimensional selective repairing system of FIG. 1;

FIG. 2B shows a schematic diagram of an area covered by a medium;

FIG. 3A shows a schematic diagram of a spraying status of the electrified pulverulent bodies of the three-dimensional selective repairing system of FIG. 1;

FIG. 3B shows a schematic diagram of electrified pulverulent bodies attaching to the medium;

FIG. 4A shows a schematic diagram of a sintering status of the three-dimensional selective repairing system of FIG. 1;

FIG. 4B shows a schematic diagram of sintered electrified pulverulent bodies;

FIG. 5 shows a flow chart of an application method applying for the three-dimensional selective repairing system according to one embodiment of the present disclosure;

FIG. 6 shows another flow chart of the application method of FIG. 5;

FIG. 7 shows a three-dimensional view of a three-dimensional selective repairing apparatus according to one embodiment of the present disclosure;

FIG. 8 shows a partial amplified view of the three-dimensional selective repairing apparatus of FIG. 7;

FIG. 9 shows a schematic diagram of an operating status of the three-dimensional selective repairing apparatus of FIG. 9; and

FIG. 10 shows a flow chart of an application method applying for the three-dimensional selective repairing apparatus according to one embodiment of the present disclosure.

### DETAILED DESCRIPTION

In the present disclosure, a horizontal direction is presented as X-axis, a direction being orthogonal to the horizontal direction is presented as Y-axis, and a direction, also called a vertical direction, being orthogonal to both X-axis and Y-axis is presented as Z-axis. The so-called “three-dimensional” means a system or an apparatus can move related to the unrepaired element along at least two axes of X-axis, Y-axis and Z-axis. Although the title of the present disclosure is named as “three-dimensional”, the relative movement along other axes is not limited thereto.

The present disclosure is for selective repairing, a user can use the device and the method to do addictive manufacturing which is not for repairing purpose. Hence, a utilization which is not relative to repair should be protected by the scope disclosed the present disclosure.

The medium is, by spraying or coating, covered on the area to form an electrostatic insulation. Because the medium has adhesive ability, the medium can be positioned at a surface of the area and allow lots of electrified pulverulent bodies to attach in the present disclosure.

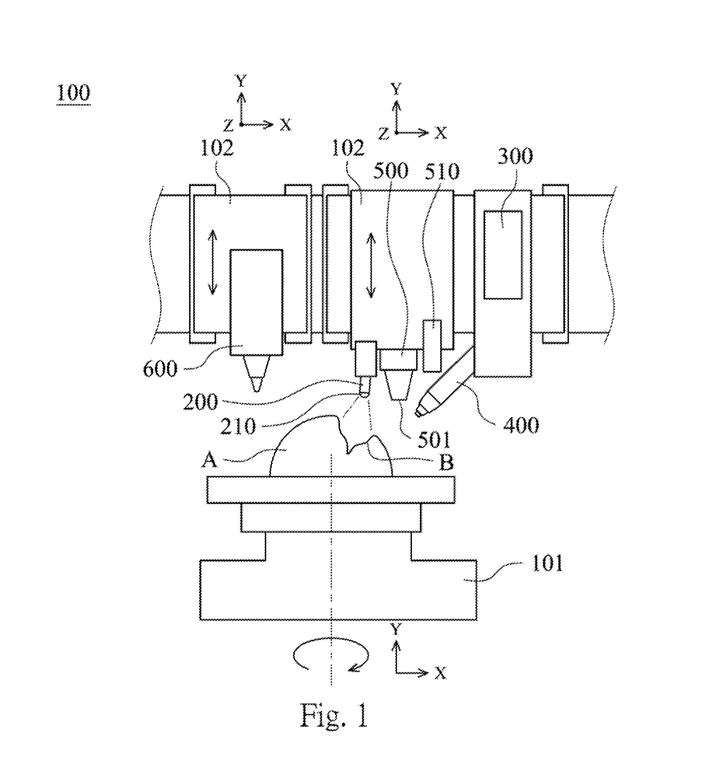

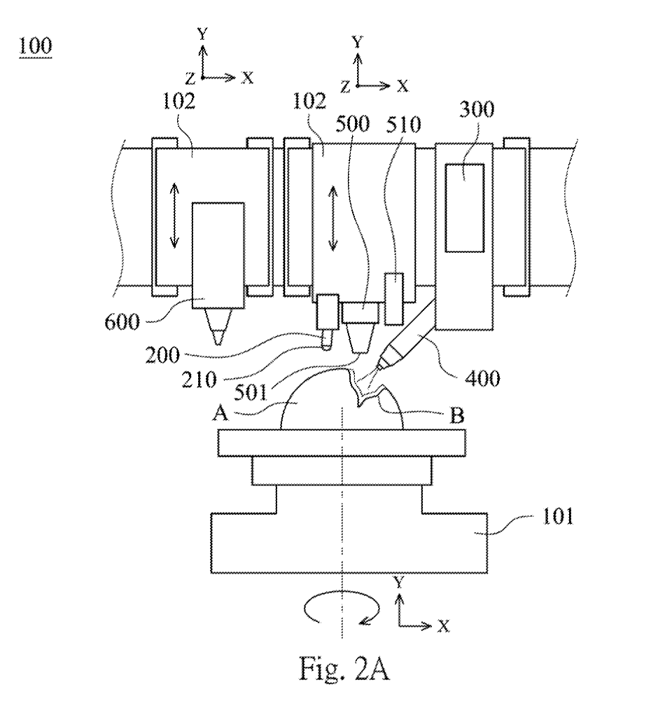

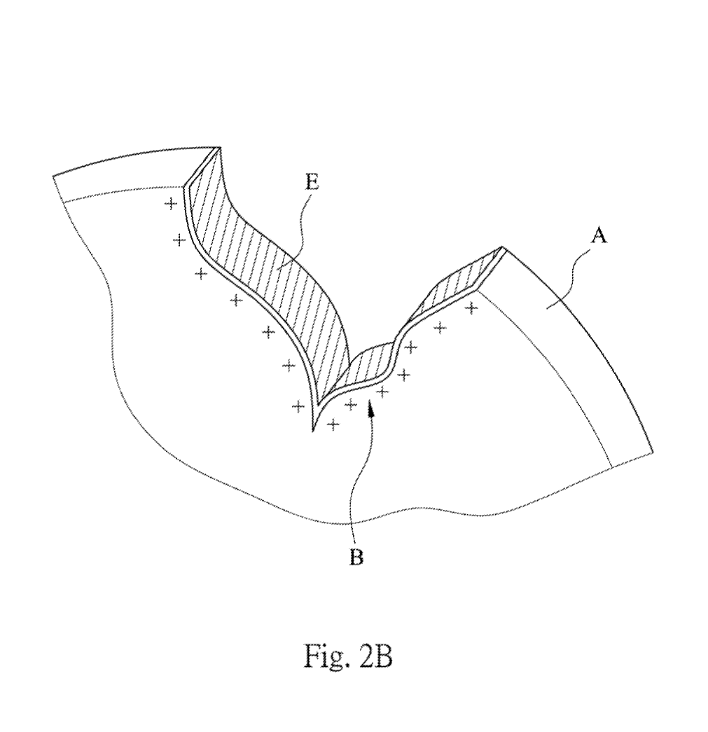

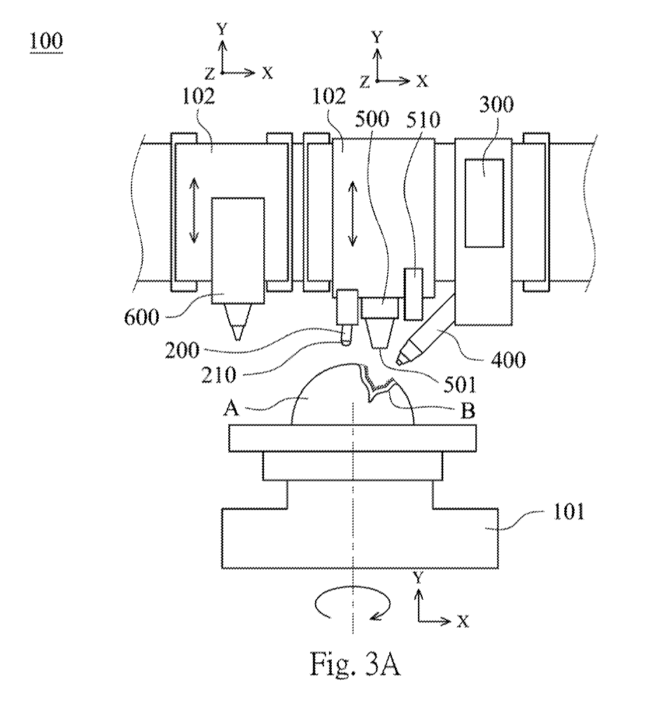

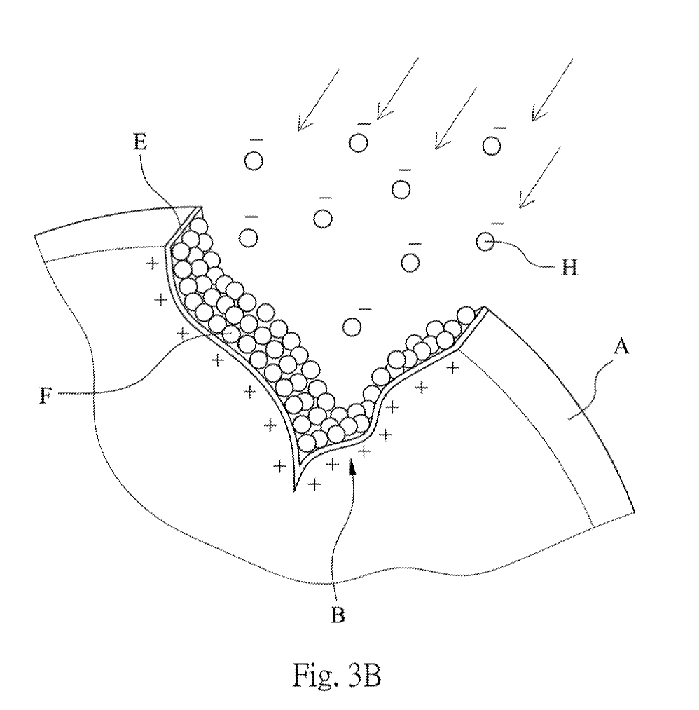

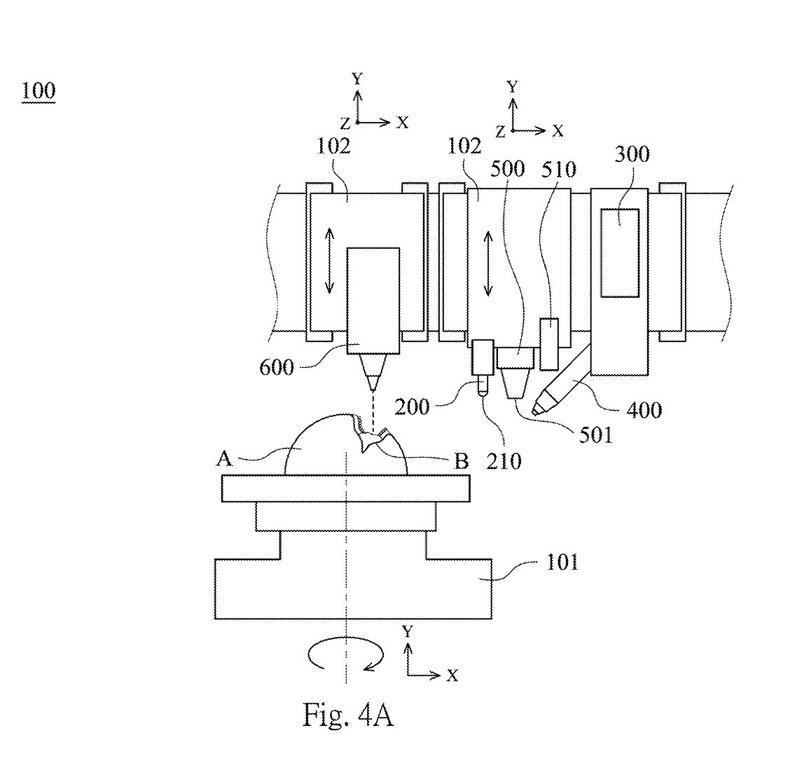

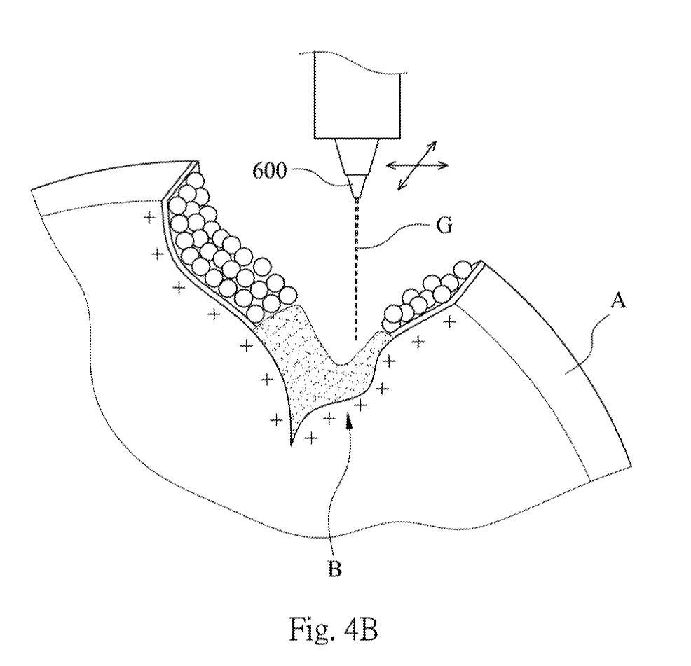

Please refer to FIG. 1 to FIG. 4B. FIG. 1 shows a schematic diagram of a three-dimensional selective repairing system 100 according to the first embodiment of the present disclosure. FIG. 2A shows a schematic diagram of a medium spraying status of the three-dimensional selective repairing system 100 of FIG. 1. FIG. 2B shows a schematic diagram of an area B covered by a medium E. FIG. 3A shows a schematic diagram of a spraying status of the electrified pulverulent bodies of the three-dimensional selective repairing system 100 of FIG. 1. FIG. 3B shows a schematic diagram of electrified pulverulent bodies H attaching to the medium E. FIG. 4A shows a schematic diagram of a sintering status of the three-dimensional selective repairing system 100 of FIG. 1. FIG. 4B shows a schematic diagram of sintered electrified pulverulent bodies. The detail structures of the first embodiment of the present disclosure can be fully disclosed upon the drawings.

The first embodiment of the present disclosure is a three-dimensional selective repairing system 100. The three-dimensional selective repairing system 100 is for selectively repairing an area B of an unrepaired element A by sintering. The three-dimensional selective repairing system 100 includes a base 101, a scanning device 200, a comparing device 300, a medium spraying device 400, a spraying device 500 and a sintering device 600. The medium spraying device 400 is for spraying a medium E to cover the area B, but the medium E can be covered on the area B by automatic-cladding, manual-cladding or manual-coating and will not be limited to automatic-spraying. In the first embodiment, the medium E is an insulating oil which is non-conductive.

The base 101 is for disposing the unrepaired element A which is three-dimensional and is made of metal material. The positive electric charges transfer from the base 101 to the unrepaired element A. The base 101 may be a part of the three-dimensional selective repairing system 100 or be an isolation mechanism. The base 101 is capable of rotation and can be moved three-dimensionally. The base 101 can be controlled to carry the unrepaired element A to a specific position.

The scanning device 200 is cooperated with a moving mechanism 102 disposed upon the base 101. The scanning device 200 can be moved three-dimensionally by the moving mechanism 102. The scanning device 200 includes a camera 210 for scanning the area B to obtain a three-dimensional image data, and the scanning device 200 gets a repairing data through the three-dimensional image data. The scanning device 200 may use a 3D scanner or other unit for measuring relative distance. The scanning device 200 may use a laser scanner to measure the surface shape to obtain a repairing data.

The comparing device 300 is connected to the scanning device 200 and receives the repairing data from the area B. By building a repairing model and relevant data of displacement and thickness on a software, the comparing device 300 can obtain a repairing parameter after calculating by program.

The medium spraying device 400 is cooperated with the moving mechanism 102 disposed upon the base 101. The medium spraying device 400 can be moved three-dimensionally by the moving mechanism 102. The medium spraying device 400 can be controlled to move according to the repairing parameter of the comparing device 300. The medium E is sprayed onto the area B by the medium spraying device 400. In the first embodiment, the medium E is an insulating oil which is non-conductive and is covered the area B.

The spraying device 500 is cooperated with the moving mechanism 102 disposed upon the base 101. The spraying device 500 also can be moved three-dimensionally by the moving mechanism 102. The spraying device 500 is controlled to move according to the repairing parameter of the comparing device 300. The spraying device 500 includes a mouth 501 and an electrostatic generator 510 disposed beside the mouth 501. The plurality of electrified pulverulent bodies H have negative electric charges because of the electrostatic generator 510. Lots of electrified pulverulent bodies H made of metal are stored in the spraying device 500. The spraying device 500 can spray the electrified pulverulent bodies H toward the surface of the medium E to form an electrified pulverulent film F on the surface of the medium E. The electrified pulverulent bodies H with negative electric charges are insulated by the medium E to indirectly attach to the area B which has positive electric charges. The electrified pulverulent bodies H can be positioned on the area B stably by the above mentioned method. At this time, the electrified pulverulent bodies H have not to be sintered or melted yet.

The sintering device 600 is cooperated with the moving mechanism 102 disposed upon the base 101. The sintering device 600 also can be moved three-dimensionally by the moving mechanism 102. The sintering device 600 is controlled to move according to the repairing parameter of the comparing device 300 and can provide a power beam G. The power beam G can be operated while moving and can selectively heat the electrified pulverulent film F, so that the electrified pulverulent film F can be melted or sintered to form a solid mass on the area B. Therefore, the area B can be repaired and solidified precisely by spraying the medium E, attaching the electrified pulverulent film F and sintering the electrified pulverulent film F by the power beam G layer-by-layer, and particular curved surface or curved fissure can be repaired. The sintering device 600 can use SLS, SLM or EBM. The power beam G can be an electric arc, an electron beam or a laser beam.

Therefore, through the utilization of the scanning device 200 and the comparing device 300, the electrified pulverulent film F can be sintered with precise position and thickness. More important, using the spraying device 500 to spray the electrified pulverulent bodies H with negative electric charges toward the medium E through the electrostatic generator 510 can make the electrified pulverulent bodies H coordinate with the medium to indirectly attach to the area B. Thus, the ability for locating the electrified pulverulent bodies H on a curved surface or a special surface can be improved. Furthermore, the electrified pulverulent bodies H can effectively attach to the area B to achieve a goal of reducing material. In the embodiment, a providing direction of the electrified pulverulent bodies H and a providing direction of the power beam G can be parallel or have an angle contained therebetween. Each of the spraying device 500 and the sintering device 600 is cooperated with the moving mechanism 102 which can be moved three-dimensionally relative to the unrepaired element A. A path of the moving mechanism 102 is controlled according to the repairing parameter.

The electrified pulverulent bodies H can be made of metal material, alloy material, metal matrix composite material, polymer, magnetic ceramic material, non-ferromagnetic material or a combination of any two or more thereof. The unrepaired element A can be an article which has positive electric charges in advance. To be more specific, the unrepaired element A can be an aeronautical equipment, a navigation equipment, a precision mold, a medical instrument, a tooth or an implanted article of human body.

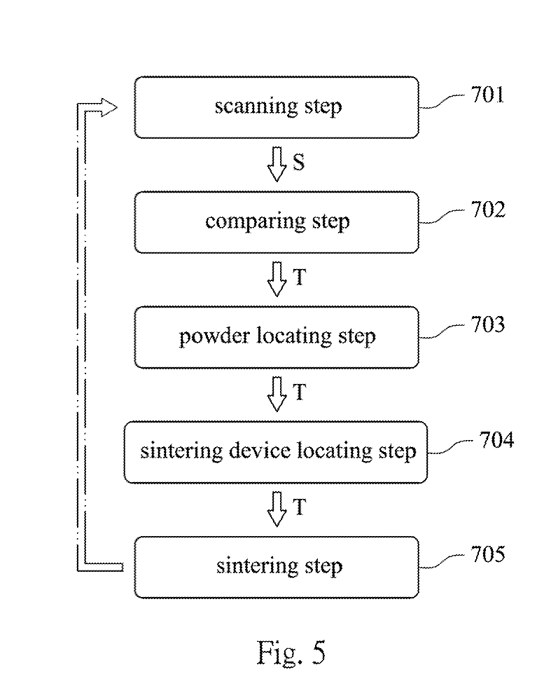

Please refer to FIG. 5. FIG. 5 shows a flow chart of an application method applying for the three-dimensional selective repairing system 100 according to one embodiment of the present disclosure. The application method includes Step 701, Step 702, Step 703, Step 704 and Step 705.

In Step 701, a scanning step is provided, and the scanning device 200 as stated in FIG. 1 to FIG. 4B is used. A repair data S is obtained by scanning the area B through the camera 210.

In Step 702, a comparing step is provided. The comparing device 300 as stated in FIG. 1 to FIG. 4 B is connected to the scanning device 200 to receive the repairing data S. The comparing device 300 builds a repairing model and relevant parameters of displacement and thickness to produce a repairing parameter T after calculating.

In Step 703, a powder locating step is provided. The spraying device 500 as stated in FIG. 1 to FIG. 4 B is moved according to the repairing parameter T. The spraying device 500 is coordinated with the medium E to allow the electrified pulverulent bodies H to attach to the area B and to form the electrified pulverulent film F with a certain thickness at a certain position according to the repairing parameter T.

In Step 704, a sintering device locating step is provided. The sintering device 600 is moved according to the repairing parameter T.

In Step 705, a sintering step is provided. The electrified pulverulent film F is, layer by layer, sintered by the sintering device 600 according to the repairing parameter T so as to be solidified; thus, the reparation of the area B can be completed. The area B, the medium E and the electrified pulverulent film F have non-flat surfaces. The method can be used in tip reparations, depressing reparations or crack reparations. Step 701 to Step 705 can be operated repeatedly to proceed the reparation of the area B.

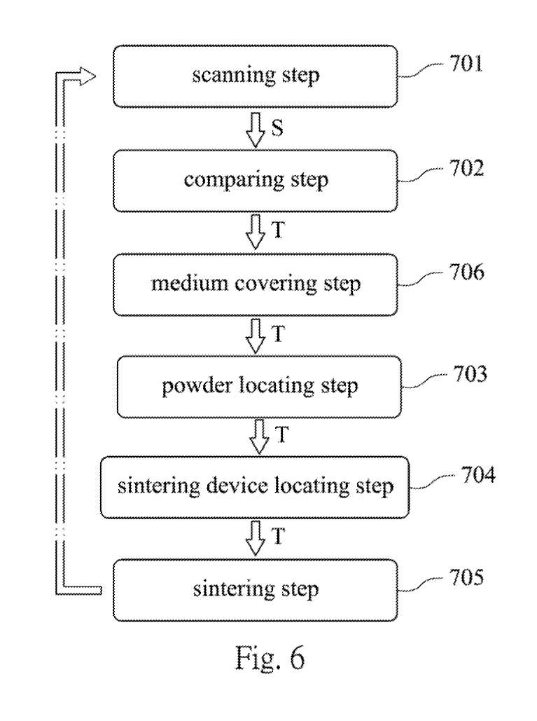

Please refer to FIG. 6. FIG. 6 shows another flow chart of the application method of FIG. 5. The application method can further include Step 706. In Step 706, a medium covering step is provided. The medium E is covered on the area B by spraying or coating before Step 703. If the medium E is sprayed by auto-spraying, the medium covering step can be done by spraying the medium E onto the area B according to the repairing parameter T. Step 701 to Step 706 can be operated repeatedly to proceed the reparation of the area B.

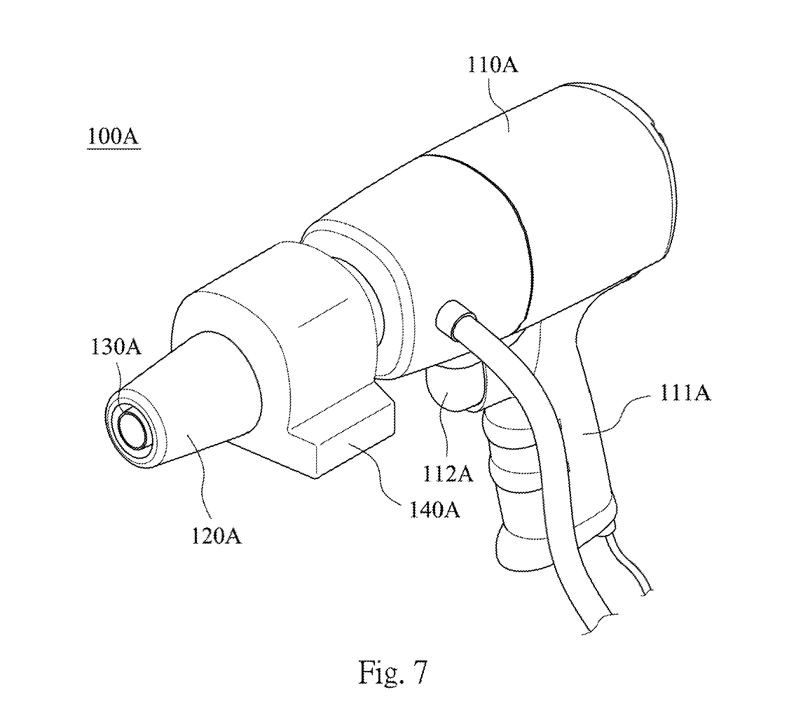

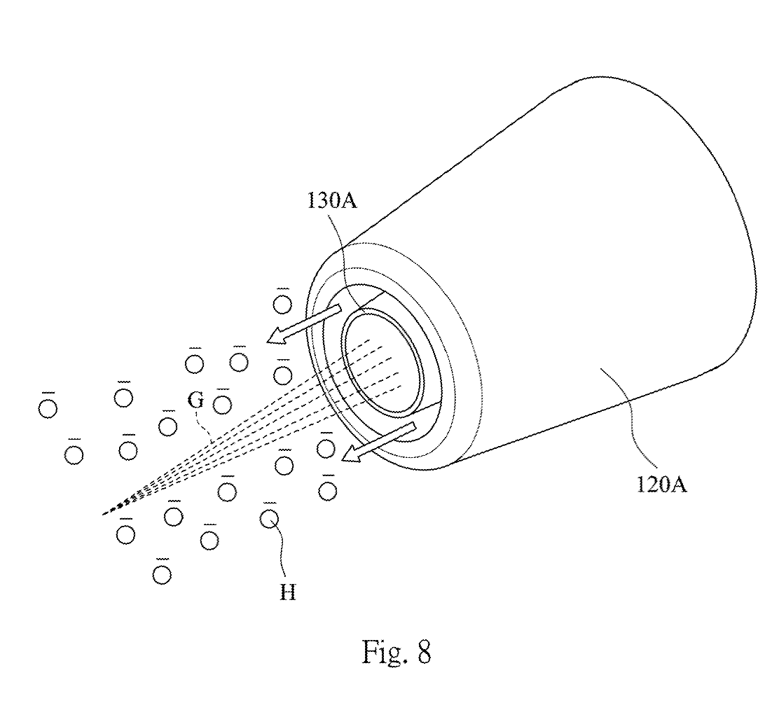

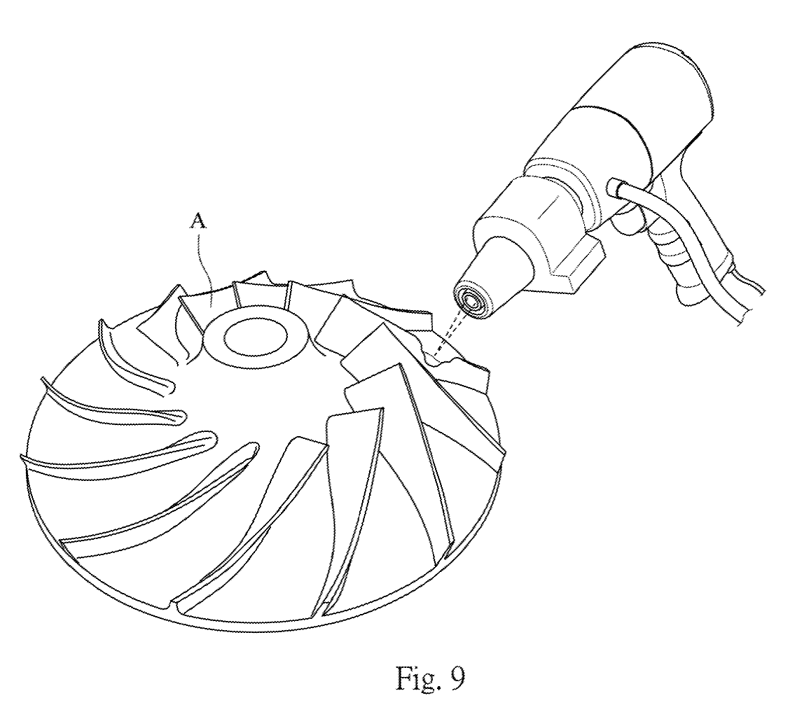

Please refer to FIG. 7 to FIG. 9. FIG. 7 shows a three-dimensional view of a three-dimensional selective repairing apparatus 100A according to one embodiment of the present disclosure. FIG. 8 shows a partial amplified view of the three-dimensional selective repairing apparatus 100A of FIG. 7. FIG. 9 shows a schematic diagram of an operating status of the three-dimensional selective repairing apparatus 100A of FIG. 9. Another three-dimensional selective repairing apparatus 100A is provides in the present disclosure. The three-dimensional selective repairing apparatus 100A is for repairing an area of an unrepaired element with positive electric charges. The area is manually covered by a medium which is non-conductive. The way the medium covered onto the unrepaired element is similar to the embodiment mentioned above and will not be described and labeled again.

The three-dimensional selective repairing apparatus 100A includes a main body 110A, a spraying device 120A, a sintering device 130A and an electrostatic generator 140A. The sintering device 130A is surrounded by the spraying device 120A. The main body 110A includes a handle 111A for handheld use. The user can hold the handle 111A to move the main body 110A easily for aiming at an outside of the area (not shown) of the unrepaired element A. The handle 111A includes a trigger 112A for controlling the spray of the electrified pulverulent bodies H and the supply of the power beam G. The electrostatic generator 140A is a high-voltage electrostatic generator. A negative electrostatic field is produced due to an ionization in an air around the area caused by the high-voltage electrostatic generator. Therefore, the spraying device 120A can spray electrified pulverulent bodies H with negative electric charges. The electrified pulverulent bodies H can coordinate with the medium (not shown) to attach to the area of the unrepaired element A. Through the design of handheld use of the main body 110A, the three-dimensional selective repairing device 100A can be operated manually. The user can connect the unrepaired element A to a positive electrode, which is a conventional technique, in advance, cover a medium which is non-conductive to the area, and then press the trigger 112A to spray the electrified pulverulent bodies H and to sinter the electrified pulverulent bodies H by providing the power beam G. The three-dimensional selective repairing apparatus 100A is favorable for repairing large ships or airplanes quickly and has advantages of metal material repairing and high strength repairing.

To be more specific, the three-dimensional selective repairing apparatus 100A can be disposed onto a robot arm or a three-dimensional moving device to bring an effect of high precise control. When spraying the electrified pulverulent bodies from a lower position toward an upper position, interaction occurs between the electrostatic force and the gravity of the electrified pulverulent bodies. A thickness of the electrified pulverulent film is corresponding to the electrostatic force and can be kept in uniform. Extra electrified pulverulent bodies will fall down because of gravity. Hence, a uniformity of the thickness will be increased.

In this embodiment, a providing direction of the electrified pulverulent bodies H is parallel to a providing direction of the power beam G, and the electrified pulverulent bodies H are sprayed surrounding the power beam G. Therefore, the size of the three-dimensional selective repairing apparatus 100A can be reduced. The sintering device 130A can use SLS, SLM or EBM. The electrified pulverulent bodies H can be made of metal material, alloy material, metal matrix composite material, polymer, magnetic ceramic material, non-ferromagnetic material or a combination thereof.

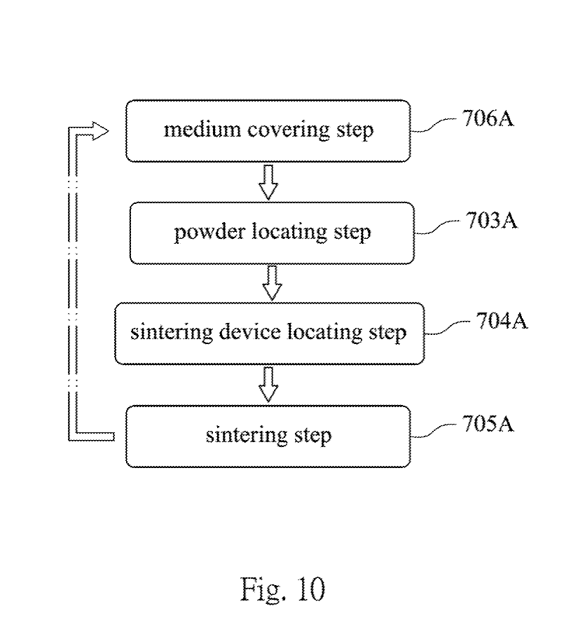

Please refer to FIG. 10, FIG. 10 shows a flow chart of an application method applying for the three-dimensional selective repairing apparatus according to one embodiment of the present disclosure. The application method is applied to the three-dimensional selective repairing apparatus 100A. The application method includes Step 706A, Step 703A, Step 704A and Step 705A. In Step 706A, a medium covering step is provided to cover a medium onto the area by spraying or coating. In Step 703A, a powder locating step is provided to use the spraying device to coordinate with the medium to attach electrified pulverulent bodies to the area and form an electrified pulverulent film with a certain thickness at a certain position. In Step 704A, a sintering device locating step is provided to use the main body to move the sintering device. In Step 705A, a sintering step is provided to use the sintering device to sinter the electrified pulverulent bodies to form a solid mass on the area. Step 706A, Step 703A, Step 704A and Step 705A can be operated repeatedly to proceed the reparation of the area B.

The three-dimensional selective repairing system, apparatus and application method disclosed in the present disclosure can provide the following effect.

1. The spraying device can spray a plurality of electrified pulverulent bodies with negative electric charges toward the medium through the electrostatic generator. The electrified pulverulent bodies can attach on the medium stably. Therefore, using the electrified pulverulent bodies to coordinate with the medium to attach to an area with positive electric charges is a good positioning method. Thus, the ability for locating on a curved surface or a special surface can be improved by using this technique.

2. The electrified pulverulent bodies can be efficiently attached to the area because of electrostatic force, and a goal of material reduction can be achieved.

3. The three-dimensional selective repairing system can provide precise reparation. Precise reparation can be achieved by controlling the spraying device and the sintering device via the repairing parameter which is provided by utilizing the base, the scanning device and the comparing device.

4. The main body of the three-dimensional selective repairing apparatus includes a handle for handheld use. The user can manually move the main body to the outside of the area; therefore, the user can arbitrarily operate the three-dimensional selective repairing apparatus to do quick sintering repair.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A three-dimensional selective repairing system, which is for selectively repairing an area of an unrepaired element by sintering, the area covered by a medium, the three-dimensional selective repairing system comprising:
a scanning device for scanning the area to obtain a repairing data;
a comparing device connected to the scanning device to receive the repairing data and producing a repairing parameter after calculating;
a spraying device controlled by the repairing parameter of the comparing device, the spraying device comprising:
an electrostatic generator, the spraying device spraying a plurality of electrified pulverulent bodies thought the electrostatic generator to form an electrified pulverulent film on the medium, the electrified pulverulent bodies coordinated with the medium to magnetically attach to the area; and
a sintering device controlled by the repairing parameter of the comparing device to provide a power beam to selectively heat the electrified pulverulent film, the electrified pulverulent film melted or sintered to form a solid mass on the area.

2. The three-dimensional selective repairing system of claim 1, wherein the spraying device and the sintering device are disposed at an outside of the area, and a providing direction of the electrified pulverulent bodies and a providing direction of the power beam are parallel or have an angle contained therebetween.

3. The three-dimensional selective repairing system of claim 1, further comprises a moving mechanism moved three-dimensionally relative to the unrepaired element, and a path of the moving device is according to the repairing parameter.

4. The three-dimensional selective repairing system of claim 1, wherein the sintering device uses selective laser sintering technique, selective laser melting technique or electron beam melting technique.

5. The three-dimensional selective repairing system of claim 1, wherein the power beam is an electric arc, an electron beam or a laser beam.

6. The three-dimensional selective repairing system of claim 1, wherein the electrified pulverulent bodies are made of metal material, alloy material, metal matrix composite material, polymer, magnetic ceramic material, non-ferromagnetic material or a combination thereof.

7. The three-dimensional selective repairing system of claim 1, wherein the medium is a plastic film or an insulating oil.

8. The three-dimensional selective repairing system of claim 7, wherein the medium is covered on the area by spraying or coating.

9. The three-dimensional selective repairing system of claim 5, wherein the electrostatic generator is a high-voltage electrostatic generator, the unrepaired element has positive electric charges, a negative electrostatic field is produced due to an ionization in an air around the area caused by the high-voltage electrostatic generator so as to attach the electrified pulverulent bodies to the unrepaired element with an interval of the medium.

10. An application method for applying to the three-dimensional selective repairing system of claim 1, comprising:
performing a scanning step to scan the area to obtain the repairing data by the scanning device;
performing a comparing step to connect the comparing device to the scanning device to receive the repairing data, wherein the comparing device produces a repair parameter after comparing and calculating;
performing a powder locating step, wherein the spraying device is moved base on the repairing parameter, and the spraying device is coordinated with the medium to allow the electrified pulverulent bodies to be magnetically disposed on the area and form the electrified pulverulent with certain thickness at a certain position;
performing a sintering device locating step to move the sintering device based on the repairing parameter; and
performing a sintering step to exert the scanning device based on the repairing parameter so as to allow the electrified pulverulent bodies to be sintered and form a solid mass on the area.

11. The application method of claim 10, wherein the area, the medium and the electrified pulverulent film are curved surfaces.

12. The application method of claim 10, further comprises:
performing a medium covering step before the powder locating step to cover the medium on the area by spraying or coating.

13. A three-dimensional selective repairing apparatus, which is for repairing an area of an unrepaired element with positive electric charges, the area covered by a medium which is non-conductive, the three-dimensional selective repair apparatus comprising:
a main body;
a spraying device disposed at and linked with the main body, the spraying device comprising:
an electrostatic generator, the spraying device spraying a plurality of electrified pulverulent bodies with negative electric charges toward the medium through the electrostatic generator to form an electrified pulverulent film on a surface of the medium, the electrified pulverulent bodies coordinated with the medium to magnetically attach to the area; and
a sintering device disposed at and linked with the main body, the sintering device controlled to provide a power beam to selectively heat the electrified pulverulent film, the electrified pulverulent film melted or sintered to form a solid mass on the area.

14. The three-dimensional selective repairing apparatus of claim 13, wherein the spraying device and the sintering device are disposed at an outside of the area, and a providing direction of the electrified pulverulent bodies and a providing direction of the power beam are parallel.

15. The three-dimensional selective repairing apparatus of claim 13, wherein the spraying device and the sintering device are disposed at an outside of the area, a providing direction of the electrified pulverulent bodies and a providing direction of the power beam are parallel, and the electrified pulverulent bodies are sprayed surrounding the power beam.

16. The three-dimensional selective repairing apparatus of claim 13, wherein the sintering device uses selective laser sintering technique, selective laser melting technique or electron beam melting technique.

17. The three-dimensional selective repairing apparatus of claim 13, wherein the power beam is an electric arc, an electron beam or a laser beam.

18. The three-dimensional selective repairing apparatus of claim 13, wherein the electrified pulverulent bodies are made of metal material, alloy material, metal matrix composite material, polymer, magnetic ceramic material, non-ferromagnetic material or a combination thereof.

19. The three-dimensional selective repairing apparatus of claim 13, wherein the electrostatic generator is a high-voltage electrostatic generator, and a negative electrostatic field is produced due to an ionization in an air around the area caused by the high-voltage electrostatic generator so as to allow the electrified pulverulent bodies to have negative electric charges.

20. The three-dimensional selective repairing apparatus of claim 13, wherein the main body comprises a handle for handheld use.

21. The three-dimensional selective repairing apparatus of claim 20, wherein the handle comprises a trigger for controlling the electrified pulverulent bodies to be sprayed or controlling the power beam to be provided.

22. The three-dimensional selective repairing apparatus of claim 20, wherein the handle comprises a trigger for controlling the electrified pulverulent bodies to be sprayed and controlling the power beam to be provided simultaneously.

23. The three-dimensional selective repairing apparatus of claim 13, wherein the main body is disposed at a robot arm or a three-dimensional moving device.

24. An application method for applying to the three-dimensional selective repairing apparatus of claim 13, comprising:
performing a medium covering step to cover the medium onto the area by spraying or coating;
performing a powder locating step, wherein the spraying device is coordinated with the medium to allow the electrified pulverulent bodies to be magnetically dispose onto the area to form an electrified pulverulent film with certain thickness at a certain position;
performing a sintering device locating step to move the sintering device via the main body; and
performing a sintering step to sintering the electrified pulverulent film to form a solid mass on the area by the sintering device.

25. The application method of claim 24, wherein the area, the medium and the electrified pulverulent film are curved surfaces.
